(19) United States
(12) Patent Application Publication
(10) Pub. No.: US 2018/0162466 A1
(43) Pub. Date: Jun. 14, 2018

(54) BUSHIING FOR TRACK ASSEMBLY

(71) Applicant: Caterpillar Inc., Peoria, IL (US)

(72) Inventor: ERIC JAMES JOHANNSEN, WASHINGTON, IL (US)

(73) Assignee: Caterpillar Inc., Peoria, IL (US)

(21) Appl. No.: 15/375,726

(22) Filed: Dec. 12, 2016

(51) Int. Cl. B62D 55/20; B62D 55/125; B62D 55/21; B62D 55/06

(52) U.S. Cl. CPC B62D 55/202; B62D 55/06; B62D 55/21; B62D 55/125

(57) ABSTRACT

A bushing is provided for use in a track assembly including a plurality of link members forming a track chain, a plurality of pin members configured to couple adjacent link members, a plurality of bushings configured to receive the pin members, and a drive sprocket including a plurality of teeth configured to engage with the plurality of bushings. The bushing may include a central axial bore configured to receive a pin member. The bushing may also include a center portion having a first diameter, the center portion being configured to engage with a concave recess defined by adjacent teeth. The bushing may further include at least one outer portion having a second diameter, the outer portion being configured to engage with a link member. A ratio between the first diameter and the second diameter may be greater than or equal to about 1.5:1.

### TECHNICAL FIELD

The present disclosure relates generally to a bushing and, more particularly, to a bushing for a track assembly.

### BACKGROUND

Track-type machines typically include a track assembly having a plurality of interlocking links or link members, each link being coupled to a ground-engaging traction panel. Adjacent links may be interconnected via a laterally disposed track pin to form a continuous track chain. Each track assembly includes a pair of parallel track chains, each track chain being made up of a series of links joined to each other by pins and/or bushings. A bushing may wrap around each track pin and be configured to provide a rotatable interface at the surface of the track pin. The bushing is adapted to engage with a portion of a drive sprocket. As a drive motor rotates the drive sprocket, teeth of the drive sprocket engage spaces between the bushings, forcing the track links to move in the direction of rotation of the drive sprocket, thereby propelling the machine.

Conventional tracks for track-type machines often use the bushing as a drive member. Such bushings engage with the drive sprocket of the vehicle. Large locomotive forces from the vehicle are transmitted from the drive sprocket into the track through the bushings. Because the bushings are often non-rotatably fixed relative to respective track links during operations, especially in high load applications, there is a great amount of scuffing action that occurs between the bushings and the drive sprocket as the bushings engage and disengage with the toothed drive sprocket. Also, because a bushing is fixed relative to the track links, only one side or portion of the bushing contacts the drive sprocket. Additionally, the typical working environment of such vehicles contains considerable abrasive materials such as sand, dust, dirt and mud. Because of all of this, the contacting side or portion of the external surface of the bushing that engages with the drive sprocket is subject to a high degree of wear, while the rest of the external surface of the bushing receives little or no wear at all. As a consequence, one area of the bushing wears out prematurely and the track links may need to be pressed off of the bushing in order to allow rotation or replacement of the bushing.

A bushing with a prolonged service life is described in U.S. Pat. No. 3,313,578 (the '578 patent) to Wright et al. The '578 patent discloses a bushing whose external surface is oval rather than cylindrical, with materials added to a side of the bushing that contacts the root of a tooth. The '578 patent discloses that in a symmetric design, additional materials may also be added to an opposite side that does not contact the root of tooth, such that the bushing may be reversed after a predetermined amount of wear has occurred. The '578 patent also discloses that in a non-symmetric design, the materials may be added to only one side of the bushing, if reversing of the bushing is not practiced.

Although the bushing of the '578 patent may have a prolonged service life, it poses challenges to the manufacturing process when only a portion or portions of the bushing are increased in thickness. Complex manufacturing processes may need to be employed in order to create the symmetric oval shape, or the non-symmetric oval shape, where materials are added to only a portion or selected portions of the bushing. As a result, the bushing of the '578 patent may increase the manufacturing complexity.

The apparatus of the present disclosure solves one or more problems set forth above and/or other problems in the art.

### SUMMARY

In accordance with one aspect, the present disclosure is directed to a bushing for use in a track assembly that may include a plurality of link members forming a track chain, a plurality of pin members configured to couple adjacent link members, a plurality of bushings configured to receive the pin members, and a drive sprocket including a plurality of teeth configured to engage with the plurality of bushings. The bushing may include a central axial bore configured to receive a pin member. The bushing may also include a center portion having a first diameter, the center portion being configured to engage with a concave recess defined by adjacent teeth. The bushing may further include at least one outer portion having a second diameter, the outer portion being configured to engage with a link member. A ratio between the first diameter and the second diameter may be greater than or equal to about 1.5:1.

According to another aspect, the present disclosure is directed to a track assembly for a machine. The track assembly may include a plurality of link members forming a track chain. The track assembly may also include a plurality of pin members, each pin member being configured to couple adjacent link members together. The track assembly may also include a drive sprocket including a plurality of teeth disposed at an outer circumferential portion of the drive sprocket, the teeth forming a plurality of concave recesses. The track assembly may further include a plurality of bushings configured to engage with the plurality of concave recesses. Each bushing may include a central axial bore configured to receive a pin member. The bushing may also include a center portion having a first diameter, the center portion being configured to engage with a concave recess. The bushing may further include at least one outer portion having a second diameter, the outer portion being configured to engage with a link member. A ratio between the first diameter and the second diameter may be greater than or equal to about 1.5:1.

According to still another aspect, the present disclosure is directed to a machine. The machine may include a frame and an engine supported by the frame. The machine may also include a plurality of link members forming a track chain. The machine may also include a plurality of pin members, each pin member being configured to couple adjacent link members together. The machine may also include a drive sprocket including a plurality of teeth disposed at an outer circumferential portion of the drive sprocket, the teeth forming a plurality of concave recesses. The machine may further include a plurality of bushings configured to engage with the plurality of concave recesses. Each bushing may include a central axial bore configured to receive a pin member. The bush may also include a center portion having a first diameter, the center portion being configured to engage with a concave recess. The bushing may further include at least one outer portion having a second diameter, the outer portion being configured to engage with a link member. A ratio between the first diameter and the second diameter is greater than or equal to about 1.5:1.

### BRIEF DESCRIPTION OF THE DRAWINGS

FIG. 1 illustrates an exemplary machine consistent with the disclosed embodiments;

FIG. 2 illustrates a cross-sectional view taken at line A-A of a portion of a track assembly of the exemplary machine of FIG. 1, consistent with the disclosed embodiments; and

FIG. 3 illustrates a side view of a portion of an exemplary drive sprocket engaged with bushings, consistent with the disclosed embodiments.

### DETAILED DESCRIPTION

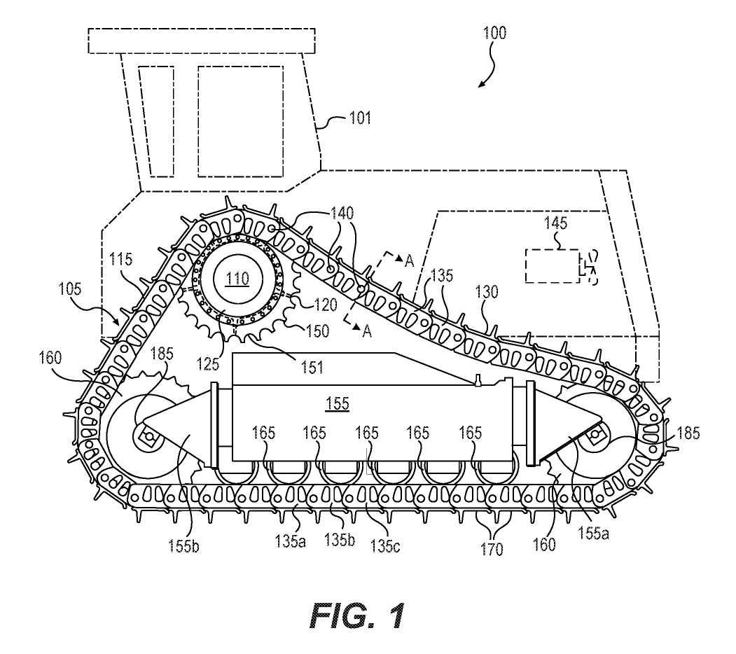

FIG. 1 illustrates an exemplary disclosed machine 100 consistent with the disclosed embodiments. Machine 100 may be a track-type machine that is driven, propelled, positioned, and/or maneuvered by operating a “continuous” track-type traction device. Such machines may include, for example, track-type tractors, skid steers, dozers, excavators, backhoes, track loaders, front shovels, or any other type of track-maneuverable machine. Machine 100 may include a frame 101 and an undercarriage 105. Undercarriage 105 may include a driving mechanism 110 and a track assembly 115. Track assembly 115 may include a drive sprocket 120 mounted on a drive hub 125 and coupled to driving mechanism 110. Track assembly 115 may also include a track chain 130 (or chain assembly) operatively coupled to driving mechanism 110 by drive sprocket 120 and configured to propel machine 100 when driven by driving mechanism 110. Track chain 130 may include a plurality of link members 135 and a plurality of pin members 140 configured to connect link members 135. For example, each pin member 140 may couple adjacent link members 135 together.

Driving mechanism 110 may include one or more components configured to generate a torque output. For example, driving mechanism 110 may include an engine 145, which may be any suitable type of internal combustion engine, such as a gasoline, diesel, natural gas, or hybrid-powered engine or turbine. Alternatively or additionally, driving mechanism 110 may include an electric motor electrically coupled to an electric power source and configured to convert at least a portion of the electrical energy output from the electric power source into mechanical energy. According to yet another embodiment, driving mechanism 110 may include a hydraulic motor fluidly coupled to a hydraulic pump and configured to convert a fluid pressurized by the hydraulic pump into a torque output.

Drive sprocket 120 may be coupled to driving mechanism 110 via a rotating shaft (not shown), which may provide an interface for delivering torque generated by driving mechanism 110 to drive sprocket 120. For example, drive sprocket 120 may be secured (e.g., welded, bolted, heat-coupled, etc.) to drive hub 125, such that drive sprocket 120 may rotate with drive hub 125 in response to the torque generated by driving mechanism 110 and delivered to drive hub 125 by the rotating shaft. According to one embodiment, drive sprocket 120 may be directly coupled via a drive shaft to driving mechanism 110. Alternatively, drive sprocket 120 may be coupled to driving mechanism 110 via a torque converter (such as a gearbox, transmission, etc.), such that rotation of drive sprocket 120 is proportional to the torque generated by driving mechanism 110.

Drive sprocket 120 may include a plurality of alternating teeth 150 and concave recesses 151 formed in between teeth 150. Teeth 150 may be configured to engage a portion of track chain 130 (e.g., spaces between bushings) such that a rotational force applied to drive sprocket 120 is delivered to track chain 130. Teeth 150 may be of any appropriate size and shape suitable to engage with track chain 130. Drive sprocket 120 may force track chain 130 to move in a direction of rotation of drive sprocket 120 when drive sprocket 120 is driven by driving mechanism 110.

As shown in FIG. 1, track assembly 115 may include a plurality of components that form a “continuous” track, the ground-engaging portion of the drive system of machine 100. Track assembly 115 may include drive sprocket 120, track chain 130, a roller frame assembly 155, at least one idler, such as at least one sprocketed idler 160, and a plurality of rollers 165. The components of track assembly 115 listed above are exemplary only and are not intended to be limiting. Accordingly, track assembly 115 may include additional and/or different components. For example, track assembly 115 may also include a plurality of track shoes 170, which may be affixed to the plurality of link members 135 to provide protective, treaded covering for link members 135. Track shoes 170 may also include cleats, protrusions, or grousers that enhance traction of track chain 130 on a ground surface.

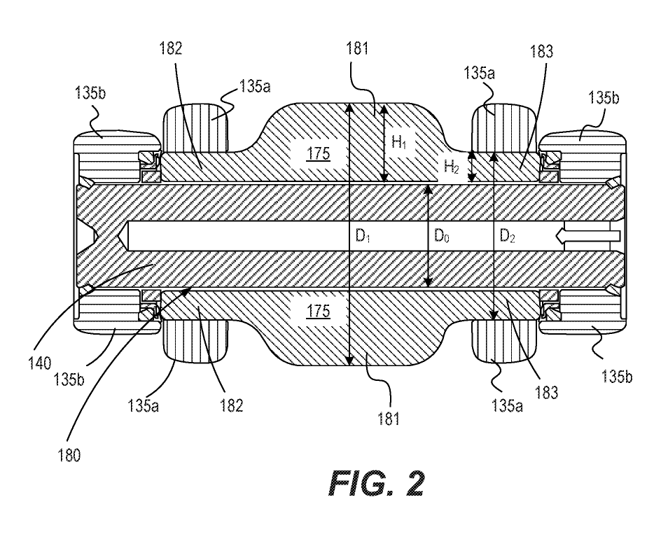

FIG. 2 shows a cross-sectional view of a portion of track chain 130 taken at the A-A line in FIG. 1. As shown in FIG. 2, each pin member 140 is provided with a bushing 175 (hence track chain 130 includes a plurality of bushings 175). Each pin member 140 may be at least partially received within a central axial bore 180 defined by inner surfaces of bushing 175. Bushing 175 may be configured to wrap around an outer surface of at least a central portion of pin member 140. Central axial bore 180 may have a diameter D₀. The diameter of pin member 140 may be substantially the same as or slightly larger than the diameter of central axial bore 180.

As shown in FIG. 2, each bushing 175 may include a center portion 181. Center portion 181 may be substantially cylindrical, and may have a first diameter D₁, and a first wall thickness H₁. As shown in FIG. 2, the first diameter D₁ may be measured between opposite portions of the outermost surface of the cylindrical shape of center portion 181. The first wall thickness H₁ may be measured between an outermost surface of the cylindrical shape of center portion 181 and an inner surface of center portion 181. Bushing 175 may also include at least one outer portion, such as a first outer portion 182 and a second outer portion 183. Although FIG. 2 shows that the two ends of center portion 181 are connected with the first outer portion 182 and the second outer portion 183 with gradually-increasing ramps, it is possible that center portion 181 may form a steep step (e.g., an approximately 90-degree vertical wall) with respect to each of first outer portion 182 and second outer portion 183. In one embodiment, first outer portion 182 and second outer portion 183 may be integral with center portion 181 such that bushing 175 is an integral single piece. In another embodiment, center portion 181 may be separate from first outer portion 182 and second outer portion 183, such that bushing 175 includes three separate pieces.

As shown in FIG. 2, first outer portion 182 and second outer portion 183 may each have a substantially cylindrical shape. In some embodiments, first outer portion 182 and second outer portion 183 may have the same second diameter D₂, and the same second wall thickness H₂. The second diameter D₂ may be measured between opposite portions of the outer surface of the cylindrical shape of first outer portion 182 or second outer portion 183. The second wall thickness H₂ may be measured between an outer surface of first outer portion 182 and an inner surface of first outer portion 182, or be measured between an outer surface of second outer portion 183 and an inner surface of second outer portion 183. In some embodiments, first outer portion 182 and second outer portion 183 may have different diameters and/or different wall thicknesses. First outer portion 182 and second outer portion 183 may each be configured to engage with a link member on each side of bushing 175.

Referring back to FIG. 1, link members 135 may be coupled together by pin members 140 to form a continuous ground-engaging track chain 130. For example, adjacent (e.g., consecutive) link members 135, such as link members 135a, 135b, and 135c, may be coupled together via pin members 140. Link members 135a, 135b, and 135c may be offset links. That is, they may each have inwardly offset ends and outwardly offset ends. An inwardly offset end of each link member 135a, 135b, 135c may be joined to an outwardly offset end of each adjacent link member. In addition, an inwardly offset end of each link member may be joined to an inwardly offset end of an opposing link member (e.g., a link member on the other side of track chain 130), and an outwardly offset end of each link member may be joined to an outwardly offset end of an opposing link member. It should be understood, however, that the link members need not be offset link members. Rather, in some embodiments, the link members may be inner link members and outer link members. In such embodiments, both ends of each opposing pair of inner link members may be sandwiched between ends of opposing outer link members.

Each pivotal section of track chain 130 may include two adjacent link members (e.g., 135a, 135b shown in FIG. 2) joined to two opposing and substantially parallel link members. As shown in FIG. 2, inwardly offset ends of each link member 135a may be secured to bushing 175 on each side. Ends of bushing 175 including at least portions of first outer portion 182 and second outer portion 183 may be at least partially positioned within bores provided at the inwardly offset ends of two opposing and substantially parallel link members 135a on the left and right sides of bushing 175. The bores provided at the inwardly offset ends of link members 135a for accommodating ends of bushing 175 may be have a diameter that is substantially the same as D₂. Similarly, outwardly offset ends at the opposite link members 135b may be secured to a pin member 140 on each side of bushing 175. Pin member 140 may be at least partially positioned within bores provided at the outwardly offset ends of two opposing and substantially parallel link members 135b. The diameter of the bores provided at the outwardly offset ends of link members 135b for accommodating pin member 140 is substantially the same as D₀.

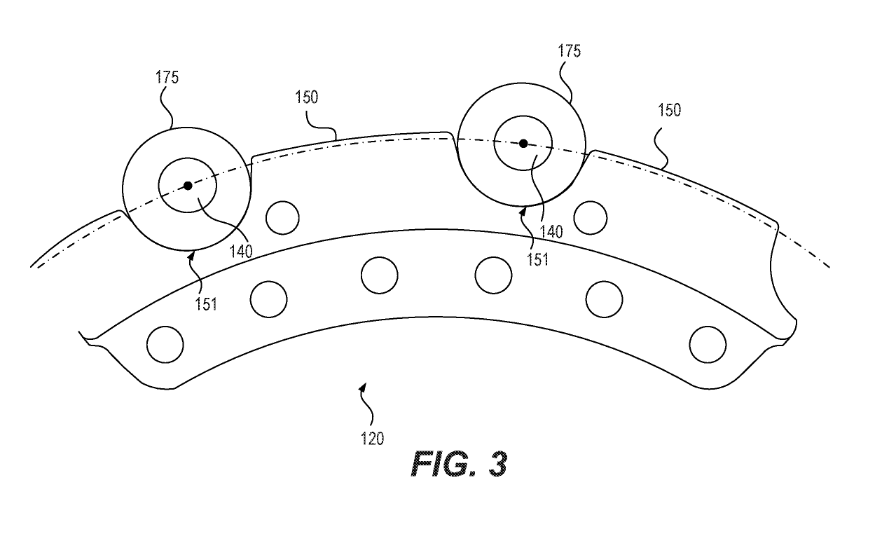

FIG. 3 illustrates a side view of a portion of drive sprocket 120 engaged with bushings 175. As shown in FIG. 3, concave recesses 151 are formed between adjacent teeth 150. Each concave recess 151 may engage with a bushing 175. Specifically, each concave recess 151 may receive a bushing 175, such that a portion of an outer surface of bushing 175 is in contact with an inner surface of concave recess 151.

As shown in FIG. 3, only a portion of each bushing 175 is in contact with concave recess 151 formed in between two adjacent teeth 150. Over time, the contacting side or portion of bushing 175 wears out. In a conventional design, the bushing is turned or rotated after a period of time (e.g., half of service life of link members) such that the non-contacting side of the bushing is rotated to be in contact with the concave recess. This typically requires placing the machine in a non-operative mode, removing track chain from the machine, and transporting the track chain to a track shop where shoes are removed from the link members and the link members are then pressed off of the pin members and bushings. Accordingly, in some conventional designs, in order to use both sides of the bushings during the service life of link members, the bushings need to be rotated.

According to a conventional design, a conventional bushing may include first diameter D₁ and second diameter D₂ that are close to each other, with D₁ being slightly larger than D₂. Existing bushings used for machine 100 may have a ratio of D₁/D₂ ranging from about 1.0 to about 1.15. For example, a conventional bushing may have D₁ is about 54 mm, D₂ is about 47 mm, and D₀ is about 29 mm, so the ratio of D₁/D₂ is about 1.15:1. As another example, a conventional bushing may have D₁ is about 110 mm, D₂ is about 106.5 mm, and D₀ is about 68 mm, so the ratio of D₁/D₂ is about 1.03:1. The term “about” is used herein to take into account normal manufacturing telerances associated with the identified dimension and/or ratio.

The bushings 175 consistent with the disclosed embodiments are no-turn bushings, which means during the service life of bushings 175, they do not need to be turned or rotated. The service life of bushings 175 is matched with the service life of link members 135. With the disclosed bushings 175, machine down time otherwise associated with turning the bushings in a conventional design can be saved, resulting in longer operating time and increased productivity for a track-type machine that uses the disclosed bushings 175.

To match the service life of link members 135, first wall thickness H₁ of center portion 181 of the disclosed bushing 175 is increased as compared to a conventional bushing. The first wall thickness H₁ may be uniformly increased around the circumference of center portion 181, such that the first diameter D₁ of bushing 175 is uniformly increased along the circumference of center portion 181. In one embodiment, thickness of center portion 181 is increased such that the ratio of D₁/D₂ is at least about 1.5:1 (or 1.5). In another embodiment, the ratio of D₁/D₂ is at least about 2.0:1 (or 2.0). For example, the ratio of D₁/D₂ may be about 1.5:1, 1.6:1, 1.7:1, 1.8:1, 1.9:1, 2.0:1, 2.1:1, 2.2:1, 2.3:1, 2.4:1, 2.5:1, or any other suitable values. In one embodiment, bushing 175 may have D₁ is about 108 mm, D₂ is about 47 mm, such that the ratio of D₁/D₂ is about 2.3:1. In another embodiment, bushing 175 may have D₁ is about 220 mm, D₂ is about 106.5 mm, such that the ratio of D₁/D₂ is about 2.06:1. Based on the geometric relationship between the ratio H₁/H₂ and D₁/D₂, H₁/H₂=(D₁-Do)/(D₂-Do), one can obtain the ratio between first wall thickness H₁ and second wall thickness H₂. When D₀ is about 29 mm, and D₂ is about 47 mm, corresponding to the above listed example ratios of D₁/D₂ from about 1.5:1 to about 2.5:1, one may obtain the ratio of H₁/H₂ to be about 2.3:1, 2.6:1, 2.8:1, 3.1:1, 3.4:1, 3.6:1, 3.9:1, 4.1:1, 4.4:1, 4.7:1, and 4.9:1. When D₀ is about 68 mm, and D₂ is about 106.5 mm, corresponding to the above listed example ratios of D₁/D₂ from about 1.5:1 to about 2.5:1, one may obtain the ratio of H₁/H₂ to be about 2.4:1, 2.7:1, 2.9:1, 3.2:1, 3.5:1, 3.8:1, 4.0:1, 4.3:1, 4.6:1, 4.9:1, and 5.1:1. Thus, in some embodiments, the ratio of H₁/H₂ may be at least about 2.3:1.

Consistent with the disclosed embodiments, the first wall thickness H₁ of center portion 181 may be uniformly increased around the circumference of center portion 181 such that center portion 181 maintains a substantially cylindrical shape. In other words, the first wall thickness H₁ of the contacting side of bushing 175 that contacts concave recess 151 is substantially the same as the thickness of the non-contacting side of bushing 175. The first wall thickness H₁ of center portion 181 of bushing 175 may be increased such that the service life of bushing 175 matches the service life of link members 135. As a result, during the service life of link members 135, bushing 175 does not need to be turned or rotated. When both the link members 135 and bushings 175 reach their service life, they may be replaced together, thereby saving the maintenance time and cost otherwise caused by rotating the bushings before the link members 135 reach their service life in a conventional design. Eliminating the need to turn the bushings may therefore increase the service time and productivity of a track-type machine. The disclosed bushings may be particularly advantageous in applications where the machine is used at remote locations where the necessary tools or facilities for removing the bushings from the track chain may not be readily accessible.

In a conventional design of bushings and drive sprocket, the bushings engage with every other concave recess of the driving sprocket. With the increased thickness at center portion 181 of bushing 175, the size of each concave recess 151 of drive sprocket 120 between a pair of teeth is also increased. That is, the distance between a pair of teeth is increased. As a result, a total number of teeth included in drive sprocket 120 is reduced as compared with a conventional drive sprocket. For example, in one embodiment, a conventional drive sprocket may include 25 teeth, and one embodiment of the disclosed drive sprocket 120 may include 12 teeth. As shown in FIG. 3, a bushing 175 is received in every concave recess 151.

Referring back to FIG. 1, roller frame assembly 155 of track assembly 115 may include one or more axles and/or any other suitable structure for supporting a substantial portion of the weight of machine 100. According to one embodiment, roller frame assembly 155 may embody the primary frame or chassis of machine 100, upon which the components (e.g., driving mechanism 110, drive sprocket 120, operator cab, etc.) of machine 100 may be mounted and secured. Although FIG. 1 depicts machine 100 as having a single roller frame assembly, machine 100 may include multiple roller frame assemblies. According to one embodiment, machine 100 may include at least one roller frame assembly 155 for each track assembly 115 associated with machine 100.

Roller frame assembly 155 may include a first portion 155a and a second portion 155b. According to one embodiment, first portion 155a may embody the front end of roller frame assembly 155, and second portion 155b may embody the rear end of roller frame assembly 155. Each of first portion 155a and second portion 155b of roller frame assembly 155 may include an idler hub 185 adapted for mounting an idler thereon, such as a sprocketed idler 160.

Roller frame assembly 155 may be configured to receive a plurality of rollers 165 that cooperate to provide a platform upon which roller frame assembly 155 may roll during movement of machine 100. Rollers 165 may embody any suitable type of heavy-duty wheel that may be configured to interact with track chain 130 so as to guide and position track chain 130 as track chain 130 travels around roller frame assembly 155. Rollers 165 may be affixed to a bottom portion of roller frame assembly 155 such that a portion of each of rollers 165 travels atop bushings 175 substantially within a channel created by interlocking link members 135 of track chain 130.

Each of first portion 155a and second portion 155b may include idler hub 185, upon which sprocketed idler 160 may be mounted. Sprocketed idler 160 may provide a mechanical interface that guides track chain 130 around roller frame assembly 155 and provides lateral support for maintaining the position of track chain 130 substantially beneath machine 100. For example, as illustrated in FIG. 1, when machine 100 is traveling forward, sprocketed idler 160 associated with first portion 155a of roller frame assembly 155 may receive track chain 130 from drive sprocket 120 and guide track chain 130 around first portion 155a, maintaining track chain 130 in position for engagement by rollers 165. Similarly, sprocketed idler 160 associated with second portion 155b may receive track chain 130 from rollers 165 beneath roller frame assembly 155 and guide track chain 130 around second portion 155b, thereby maintaining chain position for engagement by drive sprocket 120. A slack adjuster (not shown) may also be included to enable movement of sprocketed idler 160 to maintain the proper amount of tension on track chain 130, compensating for wear and other factors.

Although FIG. 1 is illustrated as a “high-drive” machine (i.e., a machine with an elevated drive system and two idler wheels), it is contemplated that the drive sprocket and bushing configurations consistent with the disclosed embodiments may be implemented in any track-type machine. For example, drive sprocket 120 may be employed in an oval-track machine, wherein driving mechanism 110 is located in-line with non-driving wheels such as rollers 165 and one of the sprocketed idlers 160.

### INDUSTRIAL APPLICABILITY

A bushing consistent with implementations disclosed and described herein provides a solution for eliminating bushing rotation during the service life of link members otherwise required in a conventional design. The wall thickness of the center portion of the bushing may be uniformly increased such that the service life of bushing is matched with the service life of link members. In some embodiments, the wall thickness of the center portion of the bushing is increased such that the ratio between the diameter of the center portion and the diameter of the outer portions of the bushing is at least 1.5:1, or at least 2.0:1. As a result, the disclosed bushings do not need to be rotated or turned during the life of link members. Time and cost otherwise associated with rotating the bushings in a conventional design may be saved. The disclosed no-turn bushings may be particularly advantageous in applications where the machine is used at remote locations where the necessary tools or facilities for removing the bushings from the machine may not be readily accessible.

In accordance with various implementations of the present disclosure, with the disclosed bushings, the time of usage of a track chain that is part of a track assembly on a mobile machine may be increased from a typical time of usage for that type of machine, before the track chain has to be removed from the track assembly for repair or replacement of worn components (e.g., the link members). To accommodate the bushings having the increased diameters, the sizes of the concave recesses on the drive sprocket are increased accordingly. In some embodiments, the number of teeth on the drive sprocket may be reduced from a total number of teeth associated with a conventional drive sprocket, such that the concave recesses formed between the teeth may be enlarged. The drive sprocket may be operatively coupled to a driving mechanism of the mobile machine, and may be configured to rotate in response to torque output generated by the driving mechanism. The drive sprocket engages with each bushing to drive the track chain.

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims.

1. A bushing for use in a track assembly including a plurality of link members forming a track chain, a plurality of pin members configured to couple adjacent link members, a plurality of bushings configured to receive the pin members, and a drive sprocket including a plurality of teeth configured to engage with the plurality of bushings, the bushing comprising:
a central axial bore configured to receive a pin member;
a center portion having a first diameter, the center portion being configured to engage with a concave recess defined by adjacent teeth; and
at least one outer portion having a second diameter, the at least one outer portion being configured to engage with a link member through a bushing bore in the link member wherein the bushing bore extends at a same diameter all the way through the link member, and,
wherein a ratio between the first diameter and the second diameter is greater than or equal to 1.5:1.

2. The bushing of claim 1, wherein the ratio between the first diameter and the second diameter is greater than or equal to 2.0:1.

3. The bushing of claim 1, wherein the ratio between the first diameter and the second diameter is in a range of 1.5:1 to 2.0:1.

4. The bushing of claim 1, wherein the first diameter is about 108 mm, the second diameter is about 47 mm, and the ratio between the first diameter and the second diameter is 2.3:1.

5. The bushing of claim 1, wherein the first diameter is about 220 mm, the second diameter is about 106.5 mm, and the ratio between the first diameter and the second diameter is 2.06:1.

6. The bushing of claim 1, wherein the center portion and the at least one outer portion are integral portions.

7. The bushing of claim 1, wherein the center portion has a substantially cylindrical shape.

8. The bushing of claim 1, wherein a ratio between a first wall thickness of the center portion and a second wall thickness of the at least one outer portion is at least 2.3:1.

9. A track assembly for a machine, the track assembly comprising:
a plurality of link members forming a track chain;
a plurality of pin members, each pin member being configured to couple adjacent link members together;
a drive sprocket including a plurality of teeth disposed at an outer circumferential portion of the drive sprocket, the teeth forming a plurality of concave recesses; and
a plurality of bushings configured to engage with the plurality of concave recesses, each bushing including:
a central axial bore configured to receive a pin member;
a center portion having a first diameter, the center portion being configured to engage with a concave recess; and
at least one outer portion having a second diameter, the at least one outer portion being configured to engage with a link member through a bushing bore in the link member wherein the bushing bore extends at a same diameter all the way through the link member, and,
wherein a ratio between the first diameter and the second diameter is greater than or equal to 1.5:1.

10. The track assembly of claim 9, wherein the ratio between the first diameter and the second diameter is greater than or equal to 2.0:1.

11. The track assembly of claim 9, wherein the ratio between the first diameter and the second diameter is in a range of 1.5:1 to 2.0:1.

12. The track assembly of claim 9, wherein the first diameter is about 108 mm, the second diameter is about 47 mm, and the ratio between the first diameter and the second diameter is 2.3:1.

13. The track assembly of claim 9, wherein the first diameter is about 220 mm, the second diameter is about 106.5 mm, and the ratio between the first diameter and the second diameter is 2.06:1.

14. The track assembly of claim 9, wherein the center portion and the at least one outer portion are integral portions.

15. The track assembly of claim 9, wherein the drive sprocket includes 12 teeth.

16. The track assembly of claim 9, wherein each concave recess is configured to engage with a bushing.

17. The track assembly of claim 8, wherein a ratio between a first wall thickness of the center portion and a second wall thickness of the at least one outer portion is at least 2.3:1.

18. The track assembly of claim 17, wherein the first wall thickness of the center portion is measured between an outermost surface of the center portion and an inner surface of the center portion.

19. The track assembly of claim 9, wherein the center portion of the bushing has a substantially cylindrical shape.

20. A machine, comprising:
a frame;
an engine supported by the frame;
a plurality of link members forming a track chain;
a plurality of pin members, each pin member being configured to couple adjacent link members together;
a drive sprocket including a plurality of teeth disposed at an outer circumferential portion of the drive sprocket, the teeth forming a plurality of concave recesses; and
a plurality of bushings configured to engage with the plurality of concave recesses, each bushing including:
a central axial bore configured to receive a pin member;
a center portion having a first diameter, the center portion being configured to engage with a concave recess; and
at least one outer portion having a second diameter, the at least one outer portion being configured to engage with a link member through a bushing bore in the link member wherein the bushing bore extends at a same diameter all the way through the link member, and,
wherein a ratio between the first diameter and the second diameter is greater than or equal to 1.5:1.
